(19) United States
(12) Patent Application Publication
(10) Pub. No.: US 2013/0244213 A1
(43) Pub. Date: Sep. 19, 2013

(54) Instructional quick connect shoelaces, a fashionable shoelace tying system utilizing multiple sensory inputs via interchangeable, unique half shoelaces attached with a quick connect buckle

(71) Applicants: Scott William Davis, Peachtree City, GA (US); Brandee Jean DAvis, Peachtree City, GA (US)

(72) Inventors: Scott William Davis, Peachtree City, GA (US); Brandee Jean DAvis, Peachtree City, GA (US)

(21) Appl. No.: 13/423,169

(22) Filed: Mar. 17, 2012

(51) Int. Cl. G09B 19/00

(52) U.S. Cl. CPC G09B 19/0076
USPC 434/260

(57) ABSTRACT

A quick connect shoelace with interchangeable half lace section.

### BACKGROUND OF THE INVENTION

Traditional shoelaces are a component of most modern shoes and shoelace tying is a necessary skill taught to children at an early age. Shoelace tying can be taught to children through example and practice and can take many months to master. Various shoelace tying methods have been proposed to help children learn to tie their shoes. However, these methods all suffer from one main weakness; shoelace confusion. The present invention helps to distinguish the individual shoelaces to reduce shoelace confusion and shorten the time it takes for a child to master tying his/her shoes.

Traditional shoelaces are typically uniform in color and texture. Regardless of tying method, one lace must be tucked or pulled under, over, or through the other and unique lace color and/or texture aids in identifying the proper lace to tuck or pull.

The idea for the invention began while watching a child attempt to tie their shoe. The child became frustrated when they were unable to identify which lace to pull to finish the knot.

### BRIEF SUMMARY OF THE INVENTION

The primary objective of the present invention is to reduce shoelace tying confusion through unique color, size, or texture on each half shoelace.

Another objective is to provide interchangeable half shoelaces to quickly change the color or texture of one side of the lace to accommodate individual learning preference.

Another objective is to provide interchangeable half shoelaces to accommodate individual color and fashion preferences.

The present invention fulfills this and other objects by providing a half shoelace that snaps together to make a complete shoelace, each composed of a unique color and/or texture.

### BRIEF DESCRIPTION OF THE SEVERAL VIEWS OF THE DRAWING

FIG. 1 is a top view of one full lace where lace 1 is of a different color and/or texture from lace 2. Lace 1 and 2 are connected by the quick release buckle 3. The buckle may be round or flat and consists of a male and female side.

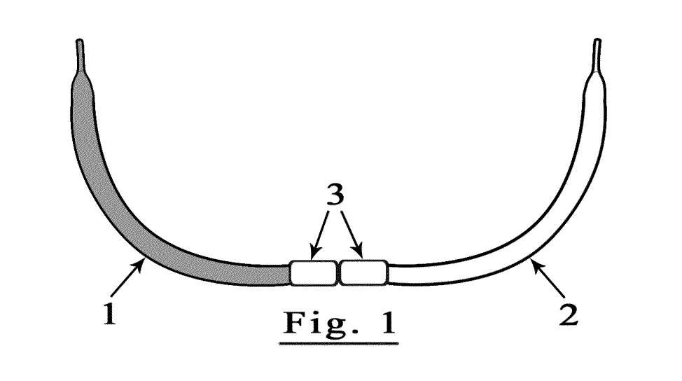

### DETAILED DESCRIPTION OF THE INVENTION

The present invention requires the combination of two commonplace items in a unique and creative manner. The shoelace portion 1 and 2 can be any type of standard shoelace. Typical shoelace material can be, but is not limited to, cotton, polyester, nylon, leather, hemp, bamboo or silk. The shoelace weave and design is not specific to the present invention, but rather, dependant on the requirements for providing uniqueness and contrast to the other half shoelace.

Each shoelace will be comprised of two unique shoelace segments 1 and 2, equal in length, with traditional shoelace tips. The end opposite the shoelace tip will be permanently connected to a plastic quick release buckle 3 in either a male or female end.

Each shoelace will have the quick release buckle 3 permanently attached to the shoelace. The full shoelace will be comprised of two half sections 1 and 2 where each half section securely, but not permanently, connects to the other half section. The full, combined shoelace from shoelace tip to shoelace tip will be sized appropriate for the given shoe. The shoelace used to teach children to tie will have a total length of approximately 38″.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim as our invention:

1. A shoelace having two unique and interchangeable half shoelace sections. Each shoelace half section shall be unique and shall be comprised of:
A quick release buckle and a shoelace with shoelace tip. The full shoelace will be comprised of two half shoelace sections where one section is uniquely different from the other and each section securely connects to the other.
